(19) United States
(12) Patent Application Publication
(10) Pub. No.: US 2015/0360717 A1
(43) Pub. Date: Dec. 17, 2015

(54) STEERING SYSTEM FOR VEHICLE AND CONTROL METHOD THEREOF

(71) Applicant: Hyundai Motor Company, Seoul (KR)

(72) Inventors: Jong Min Kim, Gwangmyeong-si (KR); Soo Bo Park, Hwaseong-si (KR)

(73) Assignee: Hyundai Motor Company, Seoul (KR)

(21) Appl. No.: 14/532,705

(22) Filed: Nov. 4, 2014

(30) Foreign Application Priority Data
Jun. 13, 2014 (KR) 10-2014-0072050

(51) Int. Cl. B62D 5/065; B62D 5/14

(52) U.S. Cl. CPC B62D 5/065; B62D 5/14

(57) ABSTRACT

A steering system for a vehicle may include a motor pump forming hydraulic pressure to apply steering output with rotational force of a motor, an actuator module applying torque to a steering wheel shaft at a rear of the steering wheel, and a controller applying operational signals to the motor pump and the actuator module, determining variation of the flow rate of steering oil by a driving condition and a steering condition of the steering wheel that affect the driving state of the vehicle, and varying a rotational force applied to the actuator module torque according to the driving condition and the steering condition when determining the flow rate variation.

### CROSS-REFERENCE TO RELATED APPLICATION

The present application claims priority to Korean Patent Application No. 10-2014-0072050, filed Jun. 13, 2014, the entire contents of which is incorporated herein for all purposes by this reference.

### BACKGROUND OF THE INVENTION

1. Field of the Invention

The present invention relates to a steering system for a vehicle and a control method thereof, and more particularly, to a steering system for a vehicle and a control method thereof, in which a steering system including a motor pump and an actuator module is implemented to improve the performance of the steering and fuel efficiency.

2. Description of Related Art

FIG. 1 is a perspective view illustrating a conventional hydraulic power steering system in which a hydraulic pump 1 is driven in conjunction with a pulley and a belt of an engine and thus fuel efficiency is decreased due to driving torque loss of the engine.

Further, according to a related hydraulic power steering system, force is transferred to a gear box 3 only when a torsion bar is twisted and a hydraulic valve is opened with the steering by a driver and thus it is impossible to transfer steering auxiliary force to the gear box without a steering intention of a driver.

Accordingly, it is impossible to control cooperating with other systems for assisting a steering force such as a parking auxiliary system, a lane keeping system, and a chassis integration control system, by using sensed information without the steering intention of a driver.

However, in a case of Motor Driven Power Steering (MDPS) for assisting the steering force with rotational force of a motor, the control of the motor for MDPS cooperating with the above systems is possible, but when MDPS is used singularly, the capacity of the motor for MDPS needs to be increased, thereby increasing the cost.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a steering system for a vehicle and a control method thereof, in which a steering system combined by a motor pump and an actuator module is implemented to improve the performance of the steering and fuel efficiency.

According to various aspects of the present invention, a steering system for a vehicle may include a motor pump foiming hydraulic pressure to apply output for steering with rotational force of a motor, an actuator module applying torque to a steering wheel shaft at a rear of the steering wheel, and a controller applying operational signals to the motor pump and the actuator module, determining a flow rate variation of steering oil by a driving condition and a steering condition of the steering wheel that reflect a driving state of the vehicle, and varying a rotational force applied to the torque actuator in accordance with the driving condition and the steering condition when determining the flow rate variation.

The motor of the motor pump may be operable in a single direction.

The method of controlling the steering system for a vehicle according to an embodiment of the present invention may include the steps of determining the flow rate variation of the steering oil by the driving condition reflecting the driving status of the vehicle and the steering condition of the steering wheel, controlling by varying the rotational force applied to the actuator module according to the driving condition and the steering condition when determining the flow rate variation.

In the determining step, it may be determined whether the flow rate is decreased to less than a base value by forming the relation of the flow rate of the steering oil with respect to a vehicle speed, a steering angle, and a speed of the steering angle.

In the variation control step, a gain value approved to an actuator module according to an increase and a decrease of the vehicle speed, the steering angle, and the speed of the steering angle may be varied when the flow rate of the steering oil is less than a base value and thus the rotational force of the actuator module may be controlled.

In the variation control step, the gain value may be decreased when the vehicle speed is increased and it may be increased when the vehicle speed is decreased.

In the variation control step, the gain value may be increased when the steering angle is increased and it may be decreased when the steering angle is decreased.

In the variation control step, the gain value may be increased when the speed of the steering angle is increased and it may be decreased when the speed of the steering angle is decreased.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view illustrating a hydraulic power steering system according to a related art.

FIG. 2 is a schematic perspective view illustrating an exemplary steering system according to the present invention.

FIG. 3 is a schematic view illustrating a motor pump in the exemplary steering system according to the present invention.

FIG. 4 is a graph and a flow chart illustrating a control method of the exemplary steering system according to the present invention.

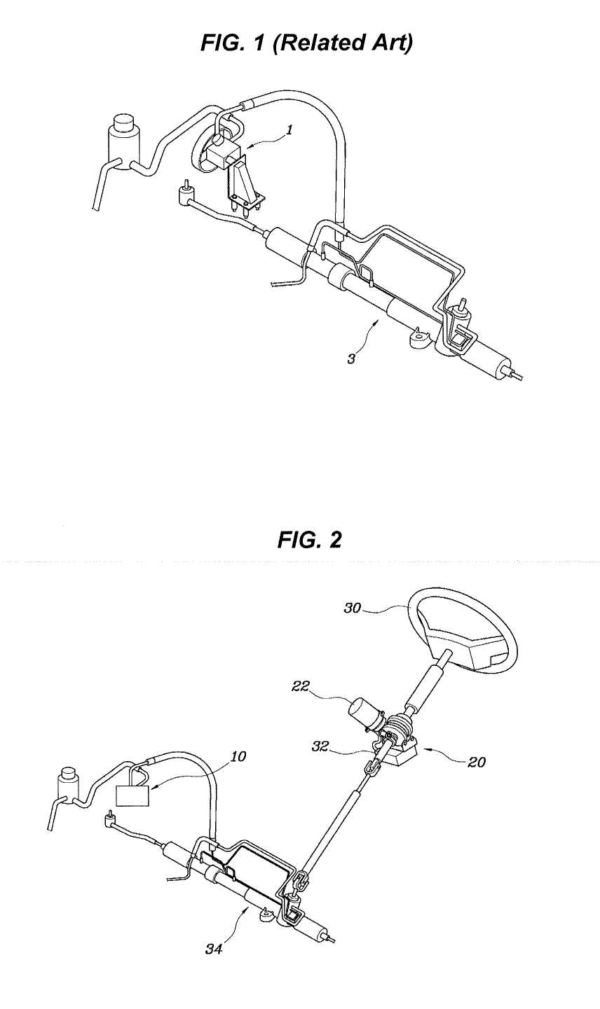

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

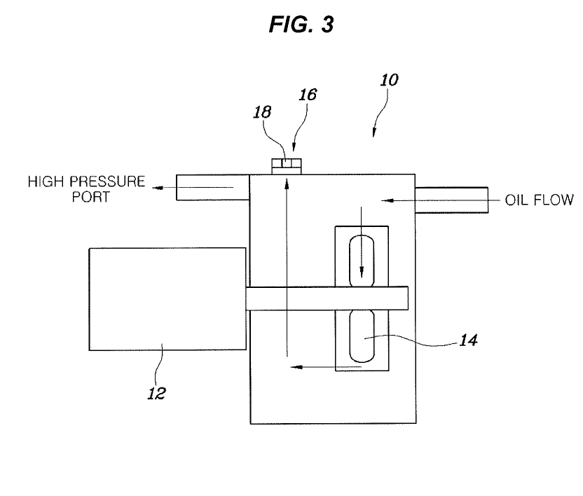

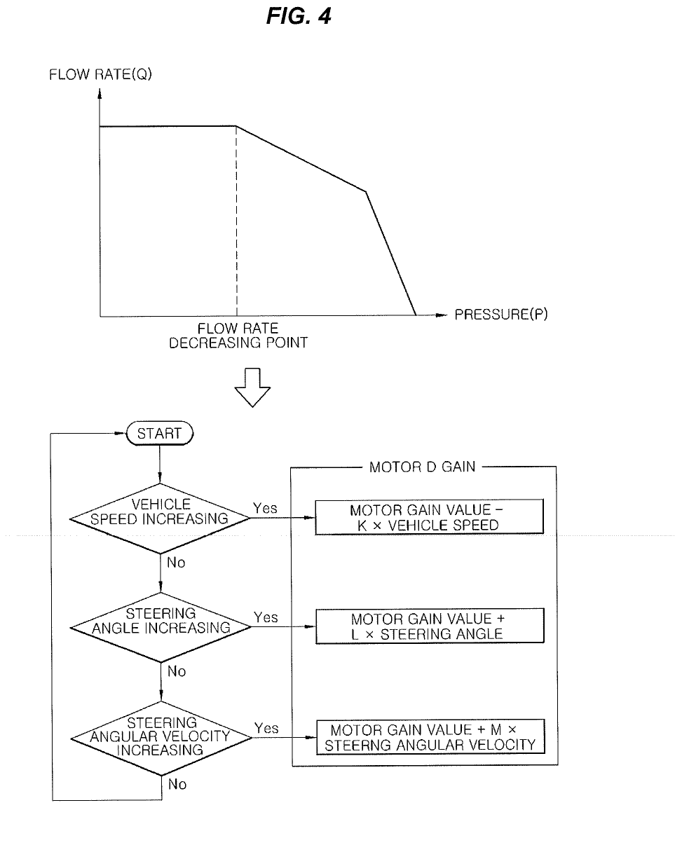

FIG. 2 is a perspective view illustrating a steering system according to various embodiments of the present invention, FIG. 3 is a schematic view illustrating a motor pump according to various embodiments of the present invention, and FIG. 4 is a graph and a flow chart illustrating a control method of the steering system according to an embodiment of the present invention.

The steering system for a vehicle mainly includes a motor pump 10, an actuator module 20, and a controller.

Referring to FIG. 2, the steering system according to various aspects of the present invention may include a motor pump 10 for forming hydraulic pressure to apply output for steering with rotational force of a motor 12, an actuator module 20 for applying torque to a steering wheel shaft 32 at the rear of a steering wheel 30, and a controller for applying operational signals to the motor pump 10 and the actuator module 20 and determining flow rate variation of steering oil by a driving condition and a steering condition of the steering wheel 30 that affect a driving state of a vehicle, and varying the rotational force to be applied to the actuator torque in accordance with the driving condition and the steering condition when determining the flow rate variation.

Here, the motor pump 10 may be provided on a passage through which steering oil flows and a steering column provided between the steering wheel 30 and the gear box 34 may be included in the steering wheel shaft 32, and the actuator module 20 may be provided in the steering column.

Further, the actuator module 20 may include a motor 22 for providing rotational force to the steering wheel 30, a torque sensor (reference numeral is omitted) for measuring rotational torque of the steering wheel 30 and a controller (reference numeral is omitted) for controlling the actuator module 20. Here, the controller may be ECU (Engine Control Unit) for controlling singularly the actuator module 20 or a controller for controlling it together with the motor 12 of the motor pump 10.

That is, the steering system is implemented by combining the motor pump 10 for applying steering force and the actuator module 20 for applying auxiliary steering torque and thus most of rack axial force required for a vehicle (70-95%) is served through the motor pump 10 and the rack axial force required for torque control for a driver (5-30%) is served through the actuator module 20.

Accordingly, the control cooperating with other systems such as a parking auxiliary system, a lane keeping system, and a chassis integration control system is possible through torque control by the actuator module 20 while the steering performance and fuel efficiency are improved through steering output from the motor pump 10, thereby improving product commerciality of a vehicle.

Meanwhile, most of rack axial force is served through an electric pump and thus a very small sized-actuator module can be used compared to a conventional MDPS thereby to save the cost, and further torque assist per vehicle speed that is controllable in MDPS and damping/recovery/crosswind compensation control can be performed thereby to improve product commerciality.

According to the present invention, the motor 12 of the motor pump 10 may be a motor 12 that is operable only in a single direction.

That is, the conventional pulley for a hydraulic pump, which is driven by an engine, is replaced with a motor of single direction that is operated only with On/Off, thereby saving cost of the motor and the system.

Furthermore, as shown in FIG. 3, the motor pump 10 generates hydraulic pressure to apply output for steering with steering oil by coupling a vane 14 to the output shaft of the motor 12 and a relief valve 16 is installed and used for controlling the pressure simply by variation in tension of a spring 18 without using the flow rate control valve of the existing hydraulic pump especially as a means to control the maximum pressure, thereby more reducing the cost of system.

Meanwhile, a method for controlling a steering system for a vehicle of the present invention may largely include a determining step and a variation control step.

Referring to FIG. 4, a method for controlling a steering system for a vehicle may include the steps of determining the flow rate of steering oil by a driving condition reflecting the driving status of a vehicle and a steering condition of a steering wheel 30, and controlling by varying the rotational force applied to an actuator module 20 according to the driving condition and steering condition.

Here, the driving condition may be a vehicle speed and the steering condition may be a steering angle, the steering angle speed and the like.

Specifically, in the determining step, the relation of flow rate of steering oil with respect to a vehicle speed, a steering angle, and the speed of a steering angle is formed, thereby determining that the flow rate is decreased to less than a base value.

That is, the flow rate of steering oil may be determined to be decreased to less than a base value by using a table or map demonstrating the relation of flow rate with respect to a vehicle speed, a steering angle, and the speed of a steering angle.

If the load required in a steering wheel 30 is decreased as a vehicle speed is increased and thus the hydraulic pressure of a motor pump 10 is reduced, the flow rate is increased.

In addition, as a steering angle is increased, if the load required in a steering wheel 30 may be increased and thus if the hydraulic pressure of a motor pump 10 is increased, the speed of flow rate may be decreased.

That is, if a driver proceeds a steering, the load of a steering wheel 30 is increased and thus the hydraulic pressure of a motor pump 10 may be increased and a situation of decreasing the flow rate occurs as the hydraulic pressure is increased. Accordingly, the steering feeling of a steering wheel 30 becomes heavier as the steering requiring torque of a steering wheel 30 is increased.

In addition, in the above variation control step, when the flow rate of the steering oil is less than a base value, the rotational force of an actuator module 20 may be controlled by varying the gain value approved to the actuator module 20 depending on the increase and decrease of the vehicle speed, the steering angle, and the speed of steering angle when the flow rate of the steering oil is less than a base value.

Specifically, in the variation control step, a gain value may be controlled to be decreased when the vehicle speed is increased and it may be controlled to be increased when the vehicle speed is decreased.

In addition, a gain value may be controlled to be increased when the steering angle is increased and it may be controlled to be decreased when the steering angle is decreased.

Furthermore, a gain value may be controlled to be increased when the speed of the steering angle is increased and it may be controlled to be decreased when the speed of the steering angle is decreased.

That is, if the flow rate is decreased to less than a base value at the determining step, the steering feeling of a steering wheel 30 becomes heavier. In this case, if a gain value approved to the motor 22 of an actuator module 20 is increased and thus the response speed of the motor 22 is improved, the steering feeling may be lightly controlled through the torque assist of a steering wheel shaft 32.

For an example, a gain value provided to a motor 22 may be decreased when the vehicle speed is increased, a gain value provided to the motor 22 when a steering angle is increased, and a gain value provided to the motor 22 may be increased when the speed of a steering angle is increased. Here, K value, L value, and M value as shown in FIG. 4 are values for scale and these may be mapping values or parameter values linked by a specific condition.

Likewise, the present invention improves the entire performance of the steering system by synchronizing the steering performance of a motor pump 10 and an actuator module 20 through a hydraulic formation for the steering output of a motor pump 10 and the rotational force control of an actuator module 20.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the claims appended hereto and their equivalents.

What is claimed is:

1. A steering system for a vehicle, comprising:
a motor pump forming hydraulic pressure to apply output for steering with rotational force of a motor;
an actuator module applying torque to a steering wheel shaft at a rear of the steering wheel; and
a controller applying operational signals to the motor pump and the actuator module, determining a flow rate variation of steering oil by a driving condition and a steering condition of the steering wheel that reflect a driving state of the vehicle, and varying a rotational force applied to the actuator module torque in accordance with the driving condition and the steering condition when determining the flow rate variation.

2. The steering system for a vehicle of claim 1, wherein the motor of the motor pump is operable in a single direction.

3. The method of controlling the steering system for the vehicle of claim 1, comprising the steps of:
determining the flow rate variation of the steering oil by the driving condition reflecting the driving status of the vehicle and the steering condition of the steering wheel;
controlling by varying the rotational force applied to the actuator module according to the driving condition and the steering condition when determining the flow rate variation.

4. The method of controlling the steering system for the vehicle of claim 3, wherein in the determining step, it is determined whether the flow rate is decreased to less than a base value by forming the relation of the flow rate of the steering oil with respect to a vehicle speed, a steering angle, and a speed of the steering angle.

5. The method of controlling the steering system for the vehicle of claim 4, wherein in the variation control step, a gain value approved to the actuator module according to an increase and a decrease of the vehicle speed, the steering angle, and the speed of the steering angle is varied when the flow rate of the steering oil is less than a base value and thus the rotational force of the actuator module is controlled.

6. The method of controlling the steering system for the vehicle of claim 5, wherein in the variation control step, the gain value is decreased when the vehicle speed is increased and the gain value is increased when the vehicle speed is decreased.

7. The method of controlling the steering system for a vehicle of claim 5, wherein in the variation control step, the gain value is increased when the steering angle is increased and the gain value is decreased when the steering angle is decreased.

8. The method of controlling the steering system for a vehicle of claim 5, wherein in the variation control step, the gain value is increased when the speed of the steering angle is increased and the gain value is decreased when the speed of the steering angle is decreased.
